(19) United States
(12) Patent Application Publication
(10) Pub. No.: US 2025/0174760 A1
(43) Pub. Date: May 29, 2025

(54) RECHARGEABLE BATTERY PACK

(71) Applicant: SAMSUNG SDI CO., LTD., Yongin-si (KR)

(72) Inventor: Giyoung KIM, Yongin-si (KR)

(21) Appl. No.: 18/811,979

(22) Filed: Aug. 22, 2024

(30) Foreign Application Priority Data
Nov. 28, 2023 (KR) 10-2023-0168370

(51) Int. Cl. H01M 10/656; A62C 2/04; A62C 3/16; H01M 10/48; H01M 10/613; H01M 50/204

(52) U.S. Cl. CPC H01M 10/656; A62C 2/04; A62C 3/16; H01M 10/482; H01M 10/486; H01M 10/613; H01M 50/204

(57) ABSTRACT

One or more embodiments of the present disclosure may include a rechargeable battery pack that includes unit batteries neighboring each other, a case including an internal space for accommodating the unit batteries, fire-extinguishing agents spaced from the unit batteries and configured to generate a solid aerosol at a set temperature, and a medium between the fire-extinguishing agents.

### CROSS-REFERENCE TO RELATED APPLICATION

The present application claims priority to and the benefit of Korean Patent Application No. 10-2023-0168370, filed on Nov. 28, 2023, in the Korean Intellectual Property Office, the entire disclosure of which is incorporated herein by reference.

### BACKGROUND

### 1. Field

Aspects of embodiments of the present disclosure relate to a rechargeable battery pack.

### 2. Description of the Related Art

Generally, a rechargeable battery may be repeatedly charged and discharged.

A rechargeable battery pack may include unit batteries and a case for receiving the unit batteries.

Some rechargeable battery packs have a problem in that if one of the unit batteries ignites, neighboring unit batteries may be ignited due to the flame generated from the ignited unit battery.

### SUMMARY

One or more embodiments of the present disclosure provide a rechargeable battery pack configured to actively extinguish an ignited unit battery from among unit batteries.

According to one or more embodiments of the present disclosure, a rechargeable battery pack may include: unit batteries neighboring each other; a case including an internal space for accommodating the unit batteries; fire-extinguishing agents spaced from the unit batteries and configured to generate a solid aerosol at a set temperature; and a medium between the fire-extinguishing agents.

The medium may include a heat transfer unit for transferring heat between the fire-extinguishing agents.

The heat transfer unit may connect the fire-extinguishing agents.

The fire-extinguishing agents may be spaced from each other by a distance equal to or greater than about 70 mm, and the heat transfer unit is located between the fire-extinguishing agents.

The medium may include a heat delay unit for blocking a gap between the fire-extinguishing agents.

The heat delay unit may cover the gap between the fire-extinguishing agents.

The fire-extinguishing agents may overlap each other with the heat delay unit therebetween.

A weight of a first fire-extinguishing agent from among the fire-extinguishing agents may satisfy Equation 1: Y=0.0088X+0.211, wherein, Y is a weight (g/L) of the first fire-extinguishing agent of the internal space of the case per volume, and X is a battery capacity (Wh) of one of the unit batteries.

In Equation 1, X may satisfy Equation 2: X=V*6.8/Z, wherein, V is a battery capacity (Wh) of one of the unit batteries, and Z is a volume (L) of the internal space of the case.

A set volume of the internal space of the case may be about 6.8 L.

A distance between a first fire-extinguishing agent from among the fire-extinguishing agents and the unit batteries may be about 2 mm to about 70 mm.

The distance between the first fire-extinguishing agent and the unit batteries may be about 2 mm to about 32 mm.

The distance between the first fire-extinguishing agent and the unit batteries may be equal to or greater than about 20 mm.

The solid aerosol may include a potassium radical.

The fire-extinguishing agents may include a mixture of a potassium compound and a resin.

The fire-extinguishing agents may further include a mesh supporting the mixture.

The mesh may be configured to penetrate the mixture.

A first fire-extinguishing agent from among the fire-extinguishing agents may be at the internal space of the case, and a second fire-extinguishing agent of the fire-extinguishing agents may be at a second internal space of a second case.

The rechargeable battery pack may further include: a battery manager connected to the unit batteries and the fire-extinguishing agents between the unit batteries and the fire-extinguishing agents, wherein the battery manager is configured to sense temperatures of the unit batteries, and is configured to heat one of the fire-extinguishing agents responsive to a temperature of one of the unit batteries being greater than the set temperature.

The battery manager may further include a heater attached to the fire-extinguishing agents, and the battery manager is configured to heat the heater.

According to an embodiment, the rechargeable battery pack configured to actively extinguishing the ignited unit battery from among the unit batteries is provided.

### BRIEF DESCRIPTION OF THE DRAWINGS

FIG. 1 shows rechargeable battery pack according to some embodiments.

FIG. 2 shows an example of fire-extinguishing agents and a medium shown in FIG. 1.

FIG. 3 shows another example of fire-extinguishing agents and a medium of a rechargeable battery pack according to some embodiments.

FIG. 4 to FIG. 6 show graphs of experimental results of checking effects according to weights of fire-extinguishing agents of a rechargeable battery pack according to some embodiments.

FIG. 7 to FIG. 9 show graphs of experimental results of checking effects according to a distance between a fire-extinguishing agent of a rechargeable battery pack and unit batteries according to some embodiments.

FIG. 10 shows a rechargeable battery pack according to some embodiments.

FIG. 11 shows a rechargeable battery pack according to some embodiments.

### DETAILED DESCRIPTION OF THE EMBODIMENTS

The present disclosure will be described more fully hereinafter with reference to the accompanying drawings, in which embodiments of the present disclosure are shown. As those skilled in the art would realize, the embodiments described herein may be modified in one or more suitable different ways, all without departing from the spirit or scope of the present disclosure.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. For example, the expression “at least one of a, b, or c” indicates only a, only b, only c, both a and b, both a and c, both b and c, all of a, b, and c, or variations thereof. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiments may be implemented independently of each other or in conjunction with each other in any suitable manner unless otherwise stated or implied.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112 (a) and 35 U.S.C. § 132 (a).

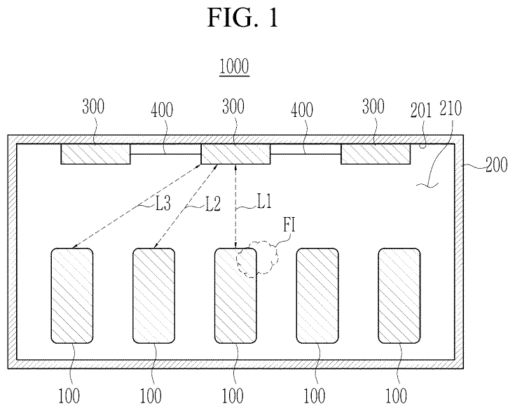

A rechargeable battery pack according to one or more embodiments will be described with reference to FIG. 1 to FIG. 9.

The rechargeable battery pack may include unit batteries and a case for receiving (or accommodating) the unit batteries. However, the rechargeable battery pack may not be limited thereto, and may include rechargeable battery modules, respectively including unit batteries and a case including the rechargeable battery modules.

FIG. 1 shows rechargeable battery pack according to some embodiments.

Referring to FIG. 1, the rechargeable battery pack 1000 may include unit batteries 100, a case 200, fire-extinguishing agents 300, and a medium 400.

The unit batteries 100 may neighbor (e.g., are adjacent to or stacked next to) each other, and may be received (or accommodated) in an internal space 210 of the case 200. The unit batteries 100 may have various suitable rechargeable battery capacities and various suitable rechargeable battery forms. For example, the respective unit batteries 100 may have battery capacity of about 18 Wh and a cylindrical shape, but are not limited thereto. The unit batteries 100 may be connected to each other in series or in parallel by utilizing various suitable connection elements. The unit batteries 100 may contact each other, and/or the unit batteries 100 may be spaced from each other, without being limited thereto. The unit batteries 100 may be arranged at a lower side of the internal space 210 of the case 200, but are not limited thereto.

The case 200 may include an internal space 210 for receiving the unit batteries 100. The internal space 210 of the case 200 may have one or more suitable space shapes for receiving (or accommodating) the rechargeable battery. The internal space 210 of the case 200 may have one or more suitable volumes. The case 200 may include one or more suitable lower covers, lateral covers, and/or upper covers for receiving (or accommodating) the unit batteries 100.

The fire-extinguishing agents 300 may be spaced from the unit batteries 100 in the internal space 210 of the case 200. The fire-extinguishing agents 300 may generate a solid aerosol at a set or reference temperature (e.g., a predetermined temperature) and may extinguish flames (FI) generated in the internal space 210.

For example, the fire-extinguishing agents 300 may generate a solid aerosol including a potassium radical at the set or predetermined temperature of about 300° C. or more. If the flame (FI) is generated by one of the unit batteries 100, at least one of the fire-extinguishing agents 300 generates the solid aerosol including a potassium radical, and an endothermic reaction for generating stable compounds is generated from the fire-extinguishing agents 300 so that the temperature in the internal space 210 of the case 200 where the flame (FI) is generated may be lowered and the ignited unit battery 100 from among the unit batteries 100 may be efficiently extinguished.

According to another example, if the flame (FI) is generated by one of the unit batteries 100, at least one of the fire-extinguishing agents 300 may generates the solid aerosol including a potassium radical, and the potassium radical deteriorates concentration of H and OH in the internal space 210 of the case 200 so that the concentration of H and OH may be minimized or reduced in the internal space 210 of the case 200 where the flame (FI) is generated, and the ignited unit battery 100 of the unit batteries 100 may be efficiently extinguished.

According to another example, the concentration of H and OH in the internal space 210 of the case 200 is deteriorated (or broken down) according to the Chemical Formula shown below by K₂O and KO that are potassium compounds included in the solid aerosol generated by at least one of the fire-extinguishing agents 300, so the ignited unit battery 100 in the internal space 210 may be extinguished.

K₂O+H⁺→2KOH,KOH+OH⁻→H₂O,KO⁻H⁺→KOH Chemical Formula

The fire-extinguishing agents 300 may be on an upper side (or area) of the internal space 210 of the case 200, but are not limited thereto. The fire-extinguishing agents 300 may be attached to an internal side 201 of the case 200 on an upper side (or area) of the internal space 210 of the case 200.

For example, the fire-extinguishing agents 300 may be attached to the internal side 201 of the case 200 by one or more suitable attaching elements such as a tape, or may be attached to the same by support elements such as a support protruding from the internal side 201 of the case 200. The fire-extinguishing agents 300 may be covered by one or more suitable cover elements such as a capsule.

The medium 400 may be located between the fire-extinguishing agents 300. The medium 400 may connect the fire-extinguishing agents 300. The medium 400 may transmit heat to a second fire-extinguishing agent 300 from a first fire-extinguishing agent 300 ignited by the flame (FI) of the ignited unit battery 100 from among the fire-extinguishing agents 300. The medium 400 may include a heat transfer unit for transmitting heat between the fire-extinguishing agents 300. The heat transfer unit of the medium 400 may connect the fire-extinguishing agents 300. The fire-extinguishing agents 300 may be spaced from each other by about 70 mm or more with the heat transfer unit of the medium 400 therebetween. The heat transfer unit of the medium 400 may include one or more suitable types (kinds) of heat transfer elements. For example, the heat transfer unit of the medium 400 may have a form in which a flammable material such as gunpowder, nitric acid potassium, or oil is coated along a line for connecting the neighboring fire-extinguishing agents 300, but is not limited thereto. For another example, the heat transfer unit of the medium 400 may include one or more suitable types (kinds) of metals for transmitting heat between the neighboring fire-extinguishing agents 300, but is not limited thereto. The heat transfer unit of the medium 400 may include one or more suitable heat transfer elements for transmitting heat of about 300° C. or more between the neighboring fire-extinguishing agents 300.

The heat transfer unit of the medium 400 may connect the fire-extinguishing agents 300 to transfer heat between the fire-extinguishing agents 300 so that the heat from the first fire-extinguishing agent 300 ignited by the flame (FI) of the ignited unit battery 100 may generate a solid aerosol to the neighboring second fire-extinguishing agent 300, and the second fire-extinguishing agent 300 may also be ignited and the second fire-extinguishing agent 300 may generate a solid aerosol if a set or predetermined time passes from the ignition of the first fire-extinguishing agent 300. The fire-extinguishing agents 300 may be sequentially heated with a set or predetermined temperature by the medium 400 to sequentially generate the solid aerosol in the internal space 210 of the case 200, thereby efficiently extinguishing the ignited unit battery 100 from among the unit batteries 100.

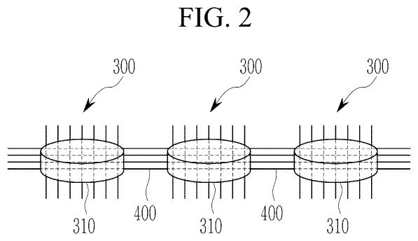

FIG. 2 shows an example of fire-extinguishing agents and a medium shown in FIG. 1.

For example, referring to FIG. 2, the fire-extinguishing agents 300 may include a mixture 310 of one or more suitable potassium compounds and one or more suitable resins and a mesh for supporting the mixture 310. The mesh may be included in the medium 400, and in some embodiments, an additional mesh may be included in the fire-extinguishing agent 300, but may not be limited thereto. The mixture 310 may have a form in which the potassium compound and the resin may be compressed at a high temperature and a high pressure, but is not limited thereto. The mesh of the medium 400 may support the mixture 310. The mesh of the medium 400 may be supported in the internal side of the case, but is not limited thereto. The mesh of the medium 400 may penetrate the mixture 310 in a horizontal direction and may support the same, but in some embodiments, it may support a lower side or an upper side of the mixture 310 but may not be limited thereto.

As the mixture 310 of the fire-extinguishing agents 300 is supported by the mesh that is the medium 400, the mixture 310 of the first fire-extinguishing agent 300 ignited by the ignited unit battery from among the fire-extinguishing agents 300 may be supported by the mesh of the medium 400. Therefore, the ignited mixture 310 may fall to the unit battery from the mesh of the medium 400, and the increase of the temperature of the unit battery may be suppressed or reduced.

The mesh of the medium 400 may include a metal, which is the heat transfer unit. The mesh of the medium 400 may connect the fire-extinguishing agents 300 to transfer heat between the fire-extinguishing agents 300, and the heat of the first fire-extinguishing agent 300 ignited by the flame of the ignited unit battery may generate a solid aerosol, which may be also transferred to the neighboring second fire-extinguishing agent 300 so that the second fire-extinguishing agent 300 may also be ignited and the second fire-extinguishing agent 300 may generate a solid aerosol if a set or predetermined time passes from the ignition of the first fire-extinguishing agent 300. The fire-extinguishing agents 300 may be sequentially heated at a set or predetermined temperature by the mesh of the medium 400 to sequentially generate a solid aerosol in the internal space of the case, thereby efficiently extinguishing the ignited unit battery from among the unit batteries.

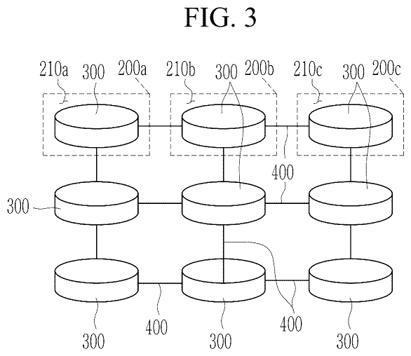

FIG. 3 shows another example of fire-extinguishing agents and a medium of a rechargeable battery pack according to an embodiments.

According to another example, referring to FIG. 3, the first fire-extinguishing agent 300 from among the fire-extinguishing agents 300 may be arranged in the first internal space 210a of the first case 200a, the second fire-extinguishing agent 300 may be arranged in the second internal space 210b of the second case 200b, and the third fire-extinguishing agent 300 may be arranged in the third internal space 210c of the third case 200c. The medium 400 may connect the first fire-extinguishing agent 300, the second fire-extinguishing agent 300, and the third fire-extinguishing agent 300 of the fire-extinguishing agents 300. The medium 400 may include a heat transfer unit. The medium 400 may connect the first fire-extinguishing agent 300 arranged in the first internal space 210a of the first case 200a, the second fire-extinguishing agent 300 arranged in the second internal space 210b of the second case 200b, and the third fire-extinguishing agent 300 arranged in the third internal space 210c of the third case 200c, to transmit heat between the fire-extinguishing agents 300. The fire-extinguishing agents 300 may be sequentially heated at a set or predetermined temperature by the medium 400 to sequentially generate a solid aerosol in the first internal space 210a of the first case 200a, the second internal space 210b of the second case 200b, and the third internal space 210c of the third case 200c, thereby efficiently extinguishing the unit batteries arranged in the internal spaces of the cases.

A weight of the first fire-extinguishing agent 300 from among the fire-extinguishing agents 300 may satisfy Equation 1.

$$Y = 0.0 \; 088 X + 0.211 \qquad Equation 1$$

Equation 1, Y is a weight (g/L) of the first fire-extinguishing agent 300 of the internal space 210 of the case 200 per volume, and X is a battery capacity (Wh) of one of the unit batteries 100 in the internal space 210 of the case 200. For example, the set or predetermined volume of the internal space 210 of the case 200 may be about 6.8 L, but is not limited thereto.

If the internal space 210 of the case 200 has various volumes, X in Equation 1 may satisfy Equation 2.

$$X = {V}^{⋆} 6.8 / Z \qquad Equation 2$$

herein Equation 2, V is the battery capacity (Wh) of one of the unit batteries 100, and the Z is the volume (L) of the internal space 210 of the case 200.

The weight (g/L) of the first fire-extinguishing agent 300 of the internal space 210 of the case 200 per volume may satisfy Equation 1 and Equation 2 so the rechargeable battery pack 1000 including the fire-extinguishing agents 300 for actively extinguishing the ignited unit battery 100 from among the unit batteries 100.

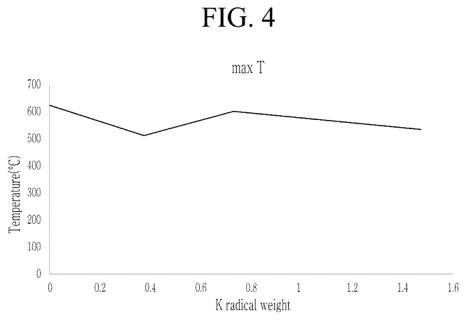

A test result of checking the effect (or effectiveness) of the first fire-extinguishing agent 300 from among the fire-extinguishing agents 300 of the rechargeable battery pack 1000 according to some embodiments according to weights will now be described with reference to FIG. 4 to FIG. 6.

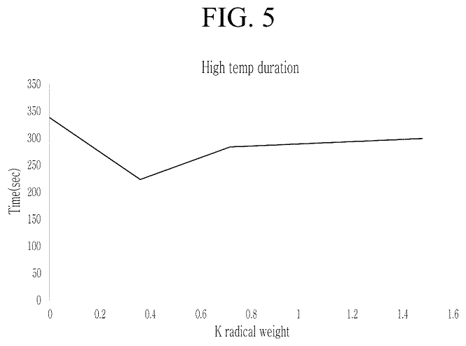

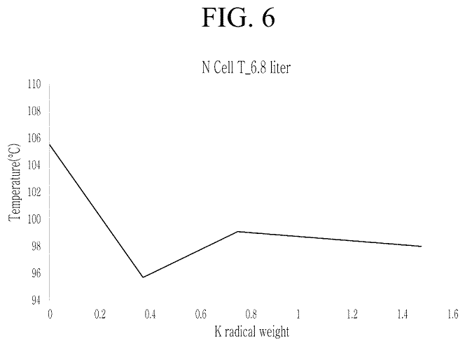

FIG. 4 to FIG. 6 show graphs of experimental results of checking the effects according to weights of fire-extinguishing agents of a rechargeable battery pack according to some embodiments. FIG. 4 shows a graph of a maximum temperature (max T) of the unit battery ignited according to the weight (K radical weight) of the fire-extinguishing agent of the internal space per volume if the internal space of the case has a volume of about 6.8 L, FIG. 5 shows a graph of a maximum temperature duration time (high temp duration) of the unit battery ignited according to the weight (K radical weight) of the fire-extinguishing agent of the internal space per volume if the internal space of the case has the volume of about 6.8 L, and FIG. 6 shows a graph of the temperature (N Cell T) of the unit battery arranged around the unit battery ignited according to the weight (K radical weight) of the fire-extinguishing agent of the internal space per volume if the internal space of the case has the volume of about 6.8 L. For example, the unit battery around the ignited unit battery may include another unit battery neighboring the ignited unit battery.

In some embodiments, FIG. 4 to FIG. 6 show that the maximum temperature (max T) of the ignited unit battery, the maximum temperature duration time (high temp duration), and the temperature (N Cell T) of the unit battery around the ignited unit battery have a lowest point if (e.g., when) the weight of the fire-extinguishing agent is about 0.37 g/L if the internal space of the case has the volume of about 6.8 L, the respective unit batteries received (or accommodated) in the internal space of the case have the battery capacity of about 18 Wh, and a distance between the fire-extinguishing agent and the unit batteries is about 2 mm to about 70 mm.

For example, Y is calculated as about 0.37 g/L if about 18 Wh is substituted for X in Equation 1.

$$Y = 0.0 \; 088 X + 0.211 \qquad Equation 1$$

Here, Y is a weight (g/L) of the first fire-extinguishing agent of the internal space of the case per volume, and X is a battery capacity (Wh) of one of the unit batteries if the internal space of the case has a set or predetermined volume.

In some embodiments, if the internal space of the case is about 6.8 L, the maximum temperature (max T) of the unit battery ignited in the internal space of the case, the maximum temperature duration time (High temp duration), and the temperature (N Cell T) of the unit battery around the ignited unit battery have the lowest point at the weight of about 0.37 g/L of the fire-extinguishing agent calculated according to Equation 1.

For example, X in Equation 1 may satisfy Equation 2 if the internal space of the case has one or more suitable volumes.

$$X = {V}^{⋆} 6.8 / Z \qquad Equation 2$$

Here, V is the battery capacity (Wh) of one of the unit batteries, and the Z is the volume (L) of the internal space of the case.

If the internal space of the case is about 0.765 L and the battery capacity of one of the unit batteries is about 18 Wh, then about 18 Wh may be substituted for V, about 0.765 L may be substituted for Z, and about 160 Wh may be calculated for X in Equation 2. If about 160 Wh is substituted for X in Equation 1, Y may be calculated as about 1.62 g/L.

If the internal space of the case is about 0.765 L, the maximum temperature of the unit battery ignited in the internal space of the case, the maximum temperature duration time, and the temperature of the unit battery around the ignited unit battery may have the lowest point at about 1.62 g/L as calculated according to Equation 1 and Equation 2.

Referring to FIG. 1, for example, the volume of the internal space 210 of the case 200 may be about 10 L, and the weight of the first fire-extinguishing agent 300 from among the fire-extinguishing agents 300 may be about 1 g to about 32 g. If the weight of the first fire-extinguishing agent 300 is less than about 1 g, it may be difficult to process the fire-extinguishing agent 300, difficult to attach the fire-extinguishing agent 300 to the internal space 210, and an amount of the fire-extinguishing agent 300 is less (e.g., a relatively small amount) so it may be difficult to extinguish the ignited unit battery 100. If the weight of the first fire-extinguishing agent 300 is greater than about 32 g, the ignited unit battery 100 may be extinguished, and the ignition may be spread to the unit batteries 100 that are arranged around the ignited unit battery 100 by the heat generated by the ignition of the fire-extinguishing agent 300. In some embodiments, a numerically limited configuration in which the volume of the internal space 210 of the case 200 is about 10 L, and the weight of the first fire-extinguishing agent 300 from among the fire-extinguishing agents 300 is about 1 g to about 32 g define threshold values for an upper value and a lower value.

Referring to FIG. 1, the distance between the first fire-extinguishing agent 300 and the unit batteries 100 may be about 2 mm to about 70 mm. For example, the distance between the first fire-extinguishing agent 300 and the unit batteries 100 may include a first distance L1 between the fire-extinguishing agent 300 and the first unit battery 100 in a vertical direction, a second distance L2 between the fire-extinguishing agent 300 and the second unit battery 100, and a third distance L3 between the fire-extinguishing agent 300 and the third unit battery 100. The distance between the first fire-extinguishing agent 300 and the unit batteries 100 may include a distance between the first fire-extinguishing agent 300 and one of the unit batteries 100 and distances between the first fire-extinguishing agent 300 and the respective unit batteries 100.

For example, if the internal space 210 of the case 200 has the volume of about 6.8 L, and the battery capacity of one of the unit batteries 100 is about 18 Wh, and the fire-extinguishing agent 300 has the weight of about 5 g, the distance between the first fire-extinguishing agent 300 and the unit batteries 100 may be about 2 mm to about 70 mm. When the distance between the first fire-extinguishing agent 300 and the unit batteries 100 is less than about 2 mm, the fire-extinguishing agent 300 hinders a path of the flame (FI) of the ignited unit battery 100, and the temperatures of the ignited unit battery 100 and the unit battery 100 around the ignited unit battery may increase by the ignited heat of the fire-extinguishing agent 300. If the distance between the first fire-extinguishing agent 300 and the unit batteries 100 is greater than about 70 mm, the heat transmitted to the fire-extinguishing agent 300 from the flame (FI) of the ignited unit battery 100 may be lower than the temperature (e.g., 300° C. or more) set to ignite the fire-extinguishing agent 300, and the fire-extinguishing agent 300 may fail to generate the solid aerosol. It may be found that a numerically limited configuration in which the distance between the first fire-extinguishing agent 300 and the unit batteries 100 is about 2 mm to about 70 mm define threshold values for an upper value and a lower value.

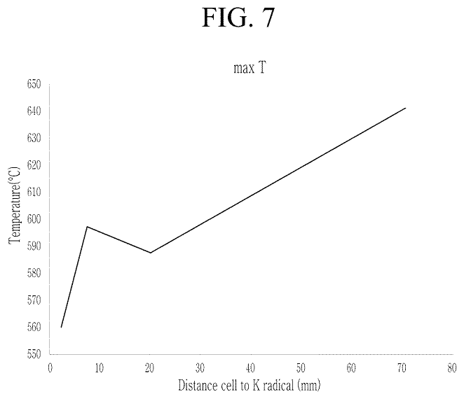

A test result of checking the effect caused by the distance between the first fire-extinguishing agent 300 of the rechargeable battery pack 1000 and the unit batteries 100 according to some embodiments will now be described with reference to FIG. 7 to FIG. 9.

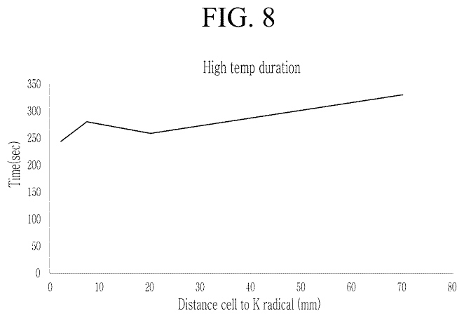

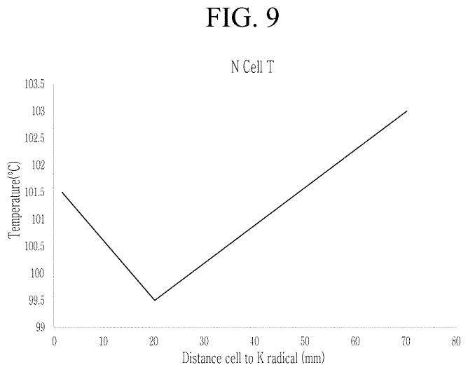

FIG. 7 to FIG. 9 show graphs of experimental results of checking the effects according to a distance between an fire-extinguishing agent of a rechargeable battery pack and unit batteries according to some embodiments. FIG. 7 shows a graph of the maximum temperature (max T) of the unit battery ignited according to the distance (distance cell to K radical) between the fire-extinguishing agent and the unit batteries if the internal space of the case has the volume of about 6.8 L, the battery capacity of one of the unit batteries is about 18 Wh, and the fire-extinguishing agent has the weight of about 5 g. FIG. 8 shows a graph of the maximum temperature duration time (high temp duration) of the unit battery ignited according to the distance (distance cell to K radical) between the fire-extinguishing agent and the unit batteries if the internal space of the case has the volume of about 6.8 L, the battery capacity of one of the unit batteries is about 18 Wh, and the fire-extinguishing agent has the weight of about 5 g. FIG. 9 shows a graph of the temperature (N Cell T) of the unit battery arranged around the unit battery ignited according to the distance (distance cell to K radical) between the fire-extinguishing agent and the unit batteries if the internal space of the case has the volume of about 6.8 L, the battery capacity of one of the unit batteries is about 18 Wh, and the fire-extinguishing agent has the weight of about 5 g.

Referring to FIG. 7 to FIG. 9, it may be found that, if the internal space of the case has the volume of about 6.8 L, the battery capacity of one of the unit batteries is about 18 Wh, and the fire-extinguishing agent has the weight of about 5 g, the maximum temperature and the maximum temperature duration time of the ignited unit battery is relatively low if (e.g., when) the distance between the unit battery and the fire-extinguishing agent is about 2 mm to about 32 mm, and the temperature of the unit battery arranged around the ignited unit battery is relatively low if (e.g., when) the distance between the unit battery and the fire-extinguishing agent is about 2 mm to about 32 mm, and it has the lowest point if (e.g., when) the distance between the unit battery and the fire-extinguishing agent is about 20 mm. This may be found as that the flame of the unit battery ignited before the fire-extinguishing agent is ignited may be hindered to induce the flame toward the unit battery that are arranged around the ignited unit battery, and the heat generated if (e.g., when) the fire-extinguishing agent is ignited is transmitted to the unit battery arranged around the ignited unit battery to increase the temperature of the unit battery arranged around the ignited unit battery.

According to the above-described test result, it may be found that the numerically limited configuration in which the distance between the fire-extinguishing agent and the unit batteries is about 2 mm to about 32 mm if the internal space of the case has the volume of about 6.8 L, the battery capacity of one of the unit batteries is about 18 Wh, and the fire-extinguishing agent has the weight of about 5 g.

It may be found that a numerically limited configuration in which the distance between the fire-extinguishing agent and the unit batteries is about 20 mm, if the internal space of the case has the volume of about 6.8 L, the battery capacity of one of the unit batteries is about 18 Wh, and the fire-extinguishing agent has the weight of about 5 g.

For example, the medium 400 may connect the fire-extinguishing agents 300 to transmit heat between the fire-extinguishing agents 300. The fire-extinguishing agents 300 may be sequentially heated at a set or predetermined temperature by the medium 400 to sequentially generate a solid aerosol in the internal space 210 of the case 200 so the rechargeable battery pack 1000 according to one or more embodiments may efficiently extinguish the ignited unit battery 100 from among the unit batteries 100.

In some embodiments, the weight (g/L) of the first fire-extinguishing agent 300 of the internal space 210 of the case 200 per volume may satisfy Equation 1, and the maximum temperature of the ignited unit battery, the maximum temperature duration time, and the temperature of the unit battery arranged around the ignited unit battery may become the lowest so the rechargeable battery pack 1000 according to one or more embodiments may actively extinguish the ignited unit battery 100 of the unit batteries 100.

The rechargeable battery pack 1000 according to one or more embodiments may include a configuration with a numerically limited threshold defining the volume of the internal space 210 of the case 200 as about 10 L, the weight of the first fire-extinguishing agent 300 is about 1 g to about 32 g, thereby actively extinguishing the ignited unit battery 100 from among the unit batteries 100.

The rechargeable battery pack 1000 according to one or more embodiments may include a configuration with a numerically limited threshold defining the distance between the first fire-extinguishing agent 300 and the unit batteries 100 to about 2 mm to about 70 mm, thereby actively extinguishing the ignited unit battery 100 from among the unit batteries 100.

The rechargeable battery pack 1000 according to one or more embodiments may include a configuration with a numerically limited threshold defining the distance between the first fire-extinguishing agent 300 and the unit batteries 100 as about 2 mm to about 32 mm, thereby actively extinguishing the ignited unit battery 100 from among the unit batteries 100.

The rechargeable battery pack 1000 according to one or more embodiments may include a configuration with a numerically limited threshold defining the distance between the first fire-extinguishing agent 300 and the unit batteries 100 as 20 mm, thereby actively extinguishing the ignited unit battery 100 from among the unit batteries 100.

The rechargeable battery pack 1000 for actively extinguishing the ignited unit battery 100 from among the unit batteries 100 is provided.

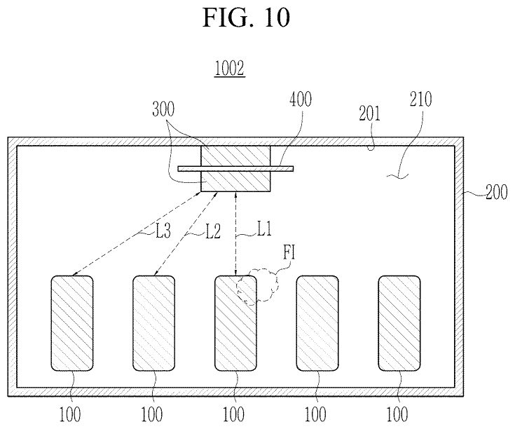

A rechargeable battery pack 1002 according to some other embodiments will now be described with reference to FIG. 10.

Portions that are different from the rechargeable battery pack according to one or more embodiments will now be described.

FIG. 10 shows a rechargeable battery pack according to some other embodiments.

Referring to FIG. 10, the rechargeable battery pack 1002 according to some other embodiments may include unit batteries 100, a case 200, fire-extinguishing agents 300, and a medium 400.

The fire-extinguishing agents 300 may overlap each other in the vertical direction with the medium 400 therebetween in the internal space 210 of the case 200. The medium 400 may be arranged between the fire-extinguishing agents 300. The medium 400 may separate the fire-extinguishing agents 300. The medium 400 may block or reduce heat from the first fire-extinguishing agent 300 ignited by the flame (FI) of the ignited unit battery 100 from among the fire-extinguishing agents 300 for a set or predetermined time. The medium 400 may include a heat delay unit for blocking gaps between the fire-extinguishing agents 300. The heat delay unit of the medium 400 may cover the gaps between the fire-extinguishing agents 300. The heat delay unit of the medium 400 may include one or more suitable types (kinds) of heat delay elements for blocking heat for a set or predetermined time. For example, the heat delay unit of the medium 400 may include paper and a resin tape for covering the gaps between the overlapped fire-extinguishing agents 300. For example, the resin tape may include one or more suitable types (kinds) of suitable resins such as polypropylene (PP), polyimide (PI), or polyethylene terephthalate (PET). The heat delay unit of the medium 400 may include one or more suitable types (kinds) of heat delay elements for delaying the heat transmitted between the overlapped fire-extinguishing agents 300 for a set or predetermined time.

The heat delay unit of the medium 400 may block or reduce the gaps between the fire-extinguishing agents 300 to delay the heat transmitted between the fire-extinguishing agents 300 for a set or predetermined time, the heat of the first fire-extinguishing agent 300 ignited by the flame (FI) of the ignited unit battery 100 among the fire-extinguishing agents 300 and generating a solid aerosol may be transmitted to the neighboring second fire-extinguishing agent 300 after a set or predetermined time so the second fire-extinguishing agent 300 may be ignited after a set or predetermined time passes from the ignition of the first fire-extinguishing agent 300, and the second fire-extinguishing agent 300 may generate a solid aerosol. The fire-extinguishing agents 300 may be sequentially heated at a set or predetermined temperature by the medium 400 to sequentially generate a solid aerosol in the internal space 210 of the case 200, thereby efficiently extinguishing the ignited unit battery 100 of the unit batteries 100.

For example, the medium 400 may block or reduce the gaps between the fire-extinguishing agents 300 to delay the heat transmitted between the fire-extinguishing agents 300 for a set or predetermined time, and the fire-extinguishing agents 300 may be sequentially heated at a set or predetermined temperature by the medium 400 to sequentially generate a solid aerosol in the internal space 210 of the case 200 so the rechargeable battery pack 1002 according to other embodiments may efficiently extinguish the ignited unit battery 100 from among the unit batteries 100.

The weight (g/L) of the first fire-extinguishing agent 300 of the internal space 210 of the case 200 per volume may satisfy Equation 1, and the maximum temperature of the ignited unit battery, the maximum temperature duration time, and the temperature of the unit battery arranged around the ignited unit battery may become the lowest so the rechargeable battery pack 1002 according to other embodiments may actively extinguish the ignited unit battery 100 from among the unit batteries 100.

The rechargeable battery pack 1002 according to other embodiments include a configuration with a numerically limited threshold in which the volume of the internal space 210 of the case 200 is about 10 L and the weight of the first fire-extinguishing agent 300 is about 1 g to about 32 g, thereby actively extinguishing the ignited unit battery 100 from among the unit batteries 100.

The rechargeable battery pack 1002 according to other embodiments include a configuration with a numerically limited threshold in which the distance between the first fire-extinguishing agent 300 and the unit batteries 100 is a pit 2 mm to about 70 mm, thereby actively extinguishing the ignited unit battery 100 from among the unit batteries 100.

The rechargeable battery pack 1002 according to other embodiments may include a configuration with a numerically limited threshold in which the distance between the first fire-extinguishing agent 300 and the unit batteries 100 is about 2 mm to about 32 mm, thereby actively extinguishing the ignited unit battery 100 from among the unit batteries 100.

The rechargeable battery pack 1002 according to other embodiments may include a configuration with a numerically limited threshold in which the distance between the first fire-extinguishing agent 300 and the unit batteries 100 is about 20 mm, thereby actively extinguishing the ignited unit battery 100 from among the unit batteries 100.

The rechargeable battery pack 1002 for actively extinguishing the ignited unit battery 100 from among the unit batteries 100 is provided.

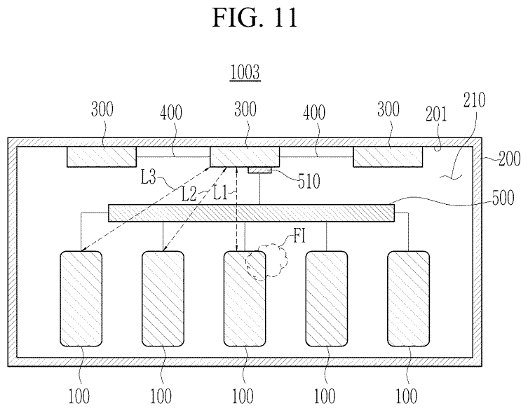

A rechargeable battery pack 1003 according to the other embodiments will now be described with reference to FIG. 11.

Portions that are different from the above-described rechargeable battery pack according to some embodiments will now be described.

FIG. 11 shows a rechargeable battery pack according to the other embodiments.

Referring to FIG. 11, the rechargeable battery pack 1003 may include unit batteries 100, a case 200, fire-extinguishing agents 300, a medium 400, and a battery manager 500.

The battery manager 500 may be arranged between the unit batteries 100 and the fire-extinguishing agents 300. The battery manager 500 may be connected to at least one of the unit batteries 100 and the fire-extinguishing agents 300. The battery manager 500 may sense the temperatures of the unit batteries 100. The battery manager 500 may heat at least one of the fire-extinguishing agents 300 if the temperature of at least one of the unit batteries 100 is greater than a set or predetermined temperature. At least one of the fire-extinguishing agents 300 heated by the battery manager 500 may generate a solid aerosol including a potassium radical, and the other fire-extinguishing agents 300 thereof may receive the heat by the medium 400 and may sequentially generate a solid aerosol.

The battery manager 500 may include a heater 510. The heater 510 may be attached to at least one of the fire-extinguishing agents 300, and the battery manager 500 may heat the heater 510 to heat the fire-extinguishing agent 300.

The battery manager 500 may include one or more suitable types (kinds) of battery management systems, and it may include a temperature sensor for sensing the temperature of the unit batteries 100 and a heating element for heating at least one of the fire-extinguishing agents 300, but may not be limited thereto.

For example, the rechargeable battery pack 1003 according to the other embodiments may include the battery manager 500 for sensing the temperature of the unit batteries 100, heating at least one of the fire-extinguishing agents 300, and sequentially generating a solid aerosol from the fire-extinguishing agents 300 to thereby actively extinguish the ignited unit battery 100 that is higher than a set or predetermined temperature or the unit battery 100 that may be ignited with a high probability from among the unit batteries 100.

The medium 400 may connect the gaps between the fire-extinguishing agents 300 to transmit the heat between the fire-extinguishing agents 300. The fire-extinguishing agents 300 may be sequentially heated at a set or predetermined temperature by the medium 400 to sequentially generate a solid aerosol in the internal space 210 of the case 200 so the rechargeable battery pack 1003 according to the other embodiments may efficiently extinguish the ignited unit battery 100 from among the unit batteries 100.

The weight (g/L) of the first fire-extinguishing agent 300 of the internal space 210 of the case 200 per volume may satisfy Equation 1. The maximum temperature of the ignited unit battery, the maximum temperature duration time, and the temperature of the unit battery arranged around the ignited unit battery may become the lowest so the rechargeable battery pack 1003 according to the other embodiments may actively extinguish the ignited unit battery 100 from among the unit batteries 100.

The rechargeable battery pack 1003 according to the other embodiments may include a configuration with a numerically limited threshold in which the volume of the internal space 210 of the case 200 is about 10 L and the weight of the first fire-extinguishing agent 300 is about 1 g to about 32 g, thereby actively extinguishing the ignited unit battery 100 from among the unit batteries 100.

The rechargeable battery pack 1003 according to the other embodiments may include a configuration with a numerically limited threshold in which the distance between the first fire-extinguishing agent 300 and the unit batteries 100 is about 2 mm to about 70 mm, thereby actively extinguishing the ignited unit battery 100 from among the unit batteries 100.

The rechargeable battery pack 1003 according to the other embodiments may include a configuration with a numerically limited threshold in which the distance between the first fire-extinguishing agent 300 and the unit batteries 100 is about 2 mm to about 32 mm, thereby actively extinguishing the ignited unit battery 100 from among the unit batteries 100.

The rechargeable battery pack 1003 according to the other embodiments may include a configuration with a numerically limited threshold in which the distance between the first fire-extinguishing agent 300 and the unit batteries 100 is about 20 mm, thereby actively extinguishing the ignited unit battery 100 from among the unit batteries 100.

The rechargeable battery pack 1003 for actively extinguishing the ignited unit battery 100 from among the unit batteries 100 is provided.

While the embodiments of the present disclosure have been described in connection with what is presently considered to be practical example embodiments, it is to be understood that the disclosure is not limited to the disclosed embodiments, but is intended to cover one or more suitable modifications and equivalent arrangements included within the spirit and scope of the appended claims and their equivalents.

### SOME REFERENCE SYMBOLS

unit battery 100, case 200, fire-extinguishing agent 300, medium 400

What is claimed is:

1. A rechargeable battery pack comprising:
unit batteries neighboring each other;
a case comprising an internal space for accommodating the unit batteries;
fire-extinguishing agents spaced from the unit batteries and configured to generate a solid aerosol at a set temperature; and
a medium between the fire-extinguishing agents.

2. The rechargeable battery pack as claimed in claim 1, wherein
the medium comprises a heat transfer unit for transferring heat between the fire-extinguishing agents.

3. The rechargeable battery pack as claimed in claim 2, wherein
the heat transfer unit connects the fire-extinguishing agents.

4. The rechargeable battery pack as claimed in claim 2, wherein
the fire-extinguishing agents are spaced from each other by a distance equal to or greater than about 70 mm, and the heat transfer unit is located between the fire-extinguishing agents.

5. The rechargeable battery pack as claimed in claim 1, wherein
the medium comprises a heat delay unit for blocking a gap between the fire-extinguishing agents.

6. The rechargeable battery pack as claimed in claim 5, wherein
the heat delay unit covers the gap between the fire-extinguishing agents.

7. The rechargeable battery pack as claimed in claim 5, wherein
the fire-extinguishing agents overlap each other with the heat delay unit therebetween.

8. The rechargeable battery pack as claimed in claim 1, wherein
a weight of a first fire-extinguishing agent from among the fire-extinguishing agents satisfies Equation 1:
$$Y = 0. 0 \; 088 X + 0.211$$
wherein, Y is a weight (g/L) of the first fire-extinguishing agent of the internal space of the case per volume, and X is a battery capacity (Wh) of one of the unit batteries.

9. The rechargeable battery pack as claimed in claim 8, wherein
in Equation 1, X satisfies Equation 2:
$$X = {V}^{⋆} 6.8 / Z$$
wherein, V is a battery capacity (Wh) of one of the unit batteries, and Z is a volume (L) of the internal space of the case.

10. The rechargeable battery pack as claimed in claim 8, wherein
a set volume of the internal space of the case is about 6.8 L.

11. The rechargeable battery pack as claimed in claim 1, wherein
a distance between a first fire-extinguishing agent from among the fire-extinguishing agents and the unit batteries is about 2 mm to about 70 mm.

12. The rechargeable battery pack as claimed in claim 11, wherein
the distance between the first fire-extinguishing agent and the unit batteries is about 2 mm to about 32 mm.

13. The rechargeable battery pack as claimed in claim 11, wherein
the distance between the first fire-extinguishing agent and the unit batteries is equal to or greater than about 20 mm.

14. The rechargeable battery pack as claimed in claim 1, wherein
the solid aerosol comprises a potassium radical.

15. The rechargeable battery pack as claimed in claim 1, wherein
the fire-extinguishing agents comprise a mixture of a potassium compound and a resin.

16. The rechargeable battery pack as claimed in claim 15, wherein
the fire-extinguishing agents further comprise a mesh supporting the mixture.

17. The rechargeable battery pack as claimed in claim 16, wherein
the mesh is configured to penetrate the mixture.

18. The rechargeable battery pack as claimed in claim 1, wherein
a first fire-extinguishing agent from among the fire-extinguishing agents is at the internal space of the case, and
a second fire-extinguishing agent of the fire-extinguishing agents is at a second internal space of a second case.

19. The rechargeable battery pack as claimed in claim 1, further comprising:
a battery manager connected to the unit batteries and the fire-extinguishing agents between the unit batteries and the fire-extinguishing agents,
wherein the battery manager is configured to sense temperatures of the unit batteries, and is configured to heat one of the fire-extinguishing agents responsive to a temperature of one of the unit batteries being greater than the set temperature.

20. The rechargeable battery pack as claimed in claim 19, wherein
the battery manager further comprises a heater attached to the fire-extinguishing agents, and
the battery manager is configured to heat the heater.
